(19) United States
(12) Patent Application Publication
(10) Pub. No.: US 2002/0084894 A1
(43) Pub. Date: Jul. 4, 2002

(54) Traffic condition monitoring system with cameras for vehicle

(76) Inventor: Chun Hsien Horng, Chu-Tung Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/752,430

(22) Filed: Jan. 3, 2001

(51) Int. Cl. B60Q 1/00

(52) U.S. Cl. 340/435; 340/436

(57) ABSTRACT

A traffic condition monitoring system with cameras for vehicle comprises four cameras, a front-or-rear control selector, a twin pictures cutting processor, a left-or-right camera selector, a picture display selector, a picture output selector and a monitor. The cameras are respectively installed at the left and right of the front and rear side of a vehicle body, and the front or rear control selector may choose front or rear cameras depending on the forward or backward driving of a vehicle. And the twin pictures cutting processor is employed to receive the signal of the cameras. The left-or-right camera selector may receive input image signals and input control signals of the left and right signal light from the front-or-rear control selector, and then decides to select a single picture from the left or right camera. The picture display selector can accept the input image signals from the twin pictures cutting processor and from left-or-right camera selector. The picture output selector can receive the input image signals from the picture display selector and the signals of left and right signal light, and finally output the image signals to the monitor. So the monitoring device not only let drivers observe the traffic condition around the car clearer and drive safer.

### TECHNICAL FIELD

The present invention relates to a traffic condition monitoring system with cameras for vehicle, particularly to a monitoring system furnished with four cameras installed around four corners of a car body so that a driver can broaden his vision to perceive the traffic condition around the car clearly.

### BACKGROUND OF THE INVENTION

Generally, the driver's vision is blocked by the structures of the two side of the car body and surrounding architectures while a car is driven out of the entrance of a lane or turned left or right. Meanwhile, for the reason that the angle of vision is limited extremely, the information of traffic condition is unable to be comprehended sufficiently, in addition, the front end of the car body is situated far away from the driver, so that what will happen before the car is quite unpredictable. Consequently, the driving safety is unable to be expected.

In the past time, a driver's vision was only limited to the visible range of the rearview mirror while a car is backing, causing a lot of dead space in driver's sight due to the limited angle of vision. So, the driver was very difficult to observe clearly the traffic condition, this may be dangerous on backing a car for the driver.

### SUMMARY OF THE INVENTION

It is thus an object of the present invention to provide a traffic condition monitoring system with cameras for vehicle. the system comprises cameras respectively installed at the left and right side of the front and rear end of a vehicle in order to let a driver extend the sight to comprehend surrounding traffic conditions.

An another object of the present invention is to provide a traffic condition monitoring system with cameras for vehicle. The system comprises a front-or-rear selecting control button and a left and right display controller, enabling the driver to choose a display way among front and rear left vision, right vision or both shown simultaneously by the way of twin picture cutting.

A still another object of the present invention is to provide a traffic condition monitoring system with cameras for vehicle, the picture selector still comprise at least one input port, enabling it to connect with other audio-video facilities.

### BRIEF DESCRIPTION OF THE DRAWINGS

A preferred embodiment of the present invention will be described in detail with reference to accompanying figures wherein:

FIG. 1 is a block diagram of a preferred embodiment of the present invention, showing the elements of the present invention and the connections among them; and

FIG. 2 is a top view of the preferred embodiment of FIG. 1, showing the installment of four cameras in a car.

### DETAILED DESCRIPTION OF THE PREFERRED EMBODIMENT OF THE PRESENT INVENTION

The present will become more apparent from a study of the following detailed description of a preferred embodiment with reference to the accompanying diagrams.

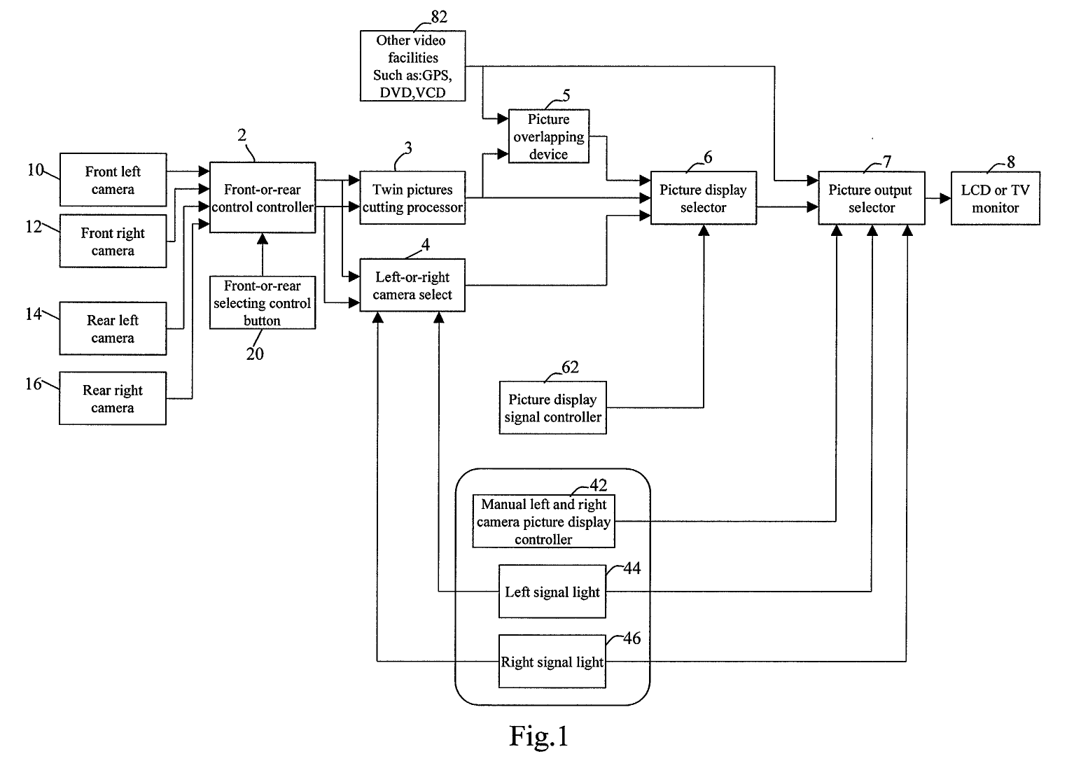

FIG. 1 is a block diagram showing a typical system configuration of a traffic condition monitoring system with cameras in a vehicle as implement by an embodiment of the present invention. As the figure shown, a front left camera 10, a front right camera 12, a rear left camera 14 and a rear right camera 16 are connected to a front-or-rear control selector 2, a front-or-rear selecting control button 20 is also connected to the front-or-rear control selector 2. And the front-or-rear control selector 2 is connected to twin pictures cutting processor 3 and a left-or-right camera selector 4. The left-or-right camera selector 4 is connected with the left signal lights 44 and right signal lights 46. The twin pictures cutting processor 3 and the left-or-right camera selector 4 are connected to a picture displaying selector 6. And wherein a pictures overlaying device 5 is connected to the twin picture cutting processor 3 and other video facilities (such as GPS, DVD and VCD) is also connected to the picture display selector 6. The picture selector 6 is connected with a picture display signal controller 62, and the picture display selector 6 is connected with picture display signal controller 62. The picture display selector 6 is connected to a picture output selector 7, and the picture output selector 7 is connected with a manual left and right camera picture display controller 42, the left signal light 44, the right signal light 46 and other video facilities 82(such as GPS, VCD, DVD. Finally, the picture output selector is connected to a monitor 8.

When a car is moving forward, front-or-rear selecting control 2 will receive input image signals from the front left camera 10 and front right camera 12. When a driver switches to the left light 44, the left-or-right camera selector 4 will receive the signal from the left signal light 44. And then the left-or-right camera selector 4 will choose the video signal of the front left camera 10 from the front-or-rear control selector 2 and transmit it to the picture display controller 6; When a driver switches to the right light 46, the left-or-right camera selector 4 will receive the signal from the right signal light 46. And then left-or-right camera selector 4 will choose the video signal of the front right camera 12 from the front-or-rear control selector 2 and transmit it to the picture display controller 6.

When a car is moving backward, front-or-rear selecting control 2 will receive input image signals from the rear left camera 14 and front right camera 16. When a driver switches to the left light 44, the left-or-right camera selector 4 will receive the signal from the left signal light 44. And then left-or-right camera selector 4 will choose the video signal of the rear left camera 14 from the front-or-rear control selector 2 and transmit it to the picture display controller 6; When a driver switches to the right light 46, the left-or-right camera selector 4 will receive the signal from the right signal light 46. And then the left-or-right camera selector 4 will choose the video signals of the rear right camera 16 from the front-or-rear control selector 2 and transmit them to the picture display controller 6.

A pictures overlapping device 5 can receive input image signals from other video facilities 82 and the twin pictures cutting processor 3, and then output the images to the picture display selector 6. The pictures overlapping device 5 enables the cutting pictures of the left and right camera to overlap on the pictures of the other video facilities.

The picture display signal controller 62 is connected to the picture display selector 6. A driver can use this picture display signal controller 62 to decide what kind of mode of pictures wants to be displayed. When the driver chooses a single picture, the picture display signal controller 62 let the picture display selector 6 choose the input image signals of the left-or-right camera selector 4. When the driver chooses left and right camera cutting pictures overlapped on the pictures of other video facilities, the picture display signal controller 62 let the picture display selector 6 choose the input image signals of the pictures overlapping device 5. When the driver chooses pure twin cutting pictures, the picture display signal controller 62 let the picture display selector 6 choose the input image signals of the twin pictures cutting processor 3.

The picture output selector 7 can receive the input image signals of the picture display selector 6 and other video facilities 82 and the control signals of the left signal light 44, right signal light 46 and manual left and right camera picture display controller 42. When the control signals are not input, the picture output selector 7 may receive the input image signals of the other video facilities 82. When the control signals is input, the picture output selector is forced to choose input image signals of the picture display selector 6. Finally, the picture output selector 7 outputs image signals onto the monitor.

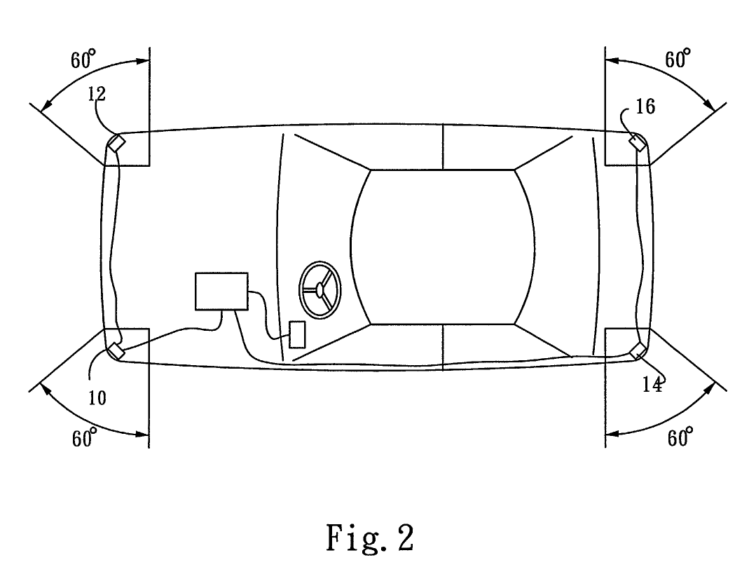

Now referring to FIG. 2, it shows the installment of four cameras in a car. As the figure shown, the best location of the front left camera 10 is at the left side of the front end of a car. The best location of the front right camera 12 is at the right side of the front end of a car. The range of angle of vision of these two cameras is approximately 30° to 90° extending from the car head to two flank sides. Also, the best location of the rear left camera 14 is at the left side of the rear end of a car. The best location of the rear right camera 16 is at the right side of the rear end of a car. The range of angle of vision of these two cameras is approximately 30° to 90° extending from the car tail to two flank sides.

However, the invention provides a photography-type traffic condition monitoring system while a driver is driving a car forward or backward, but for the purpose that the image comes from the left camera doesn't show on the right side of the monitor and vise versa, so output mirror video signal must be used in the two rear cameras. This will make the picture shown on the monitor 8 is coincident with the real vision of the driver so that he can make a correct judgement on backward driving.

As indicated above, the present invention utilizes a photography-type traffic condition monitoring system to extend a driver vision and to provide the traffic condition around a car, enabling the driver to make a safety driving.

It is to be understood that the drawing is designed for purpose of illustration only, and is not intended for use as a definition of the limits and scope of the invention disclosed.

What is claimed is:

1. A traffic condition monitoring system with cameras for vehicle, comprising:
two cameras installed at the left and right flank side of the front end of a vehicle respectively;
a twin pictures cutting processor, connected to said two cameras, receiving and processing input image signals;
a picture display selector, connected to said twin pictures cutting processor, receiving input image signals from said twin pictures cutting processor;
a picture output selector, connected to said picture display selector and the left and right signal lights, receiving the image signals input from said picture display selector and sensing the input signals of the left and right signal light; and
a monitor, connected to a picture output selector, receiving and displaying the input signal from said picture output selector.

2. The system of claim 1, further comprising a left-or-right camera selector, connected to said cameras, picture display selector and the left and right signal light, receiving the image signals of said two cameras and outputting the image signals to said picture display selector, and sensing input signals of the left and right signal light to decide to choose the single picture of said left or right camera.

3. The system of claim 1, further comprising:
a manual left and right camera picture display controller, connected to said picture output selector, said controller can let the pictures of the left and right camera display on said monitor simultaneously.

4. The system of claim 1, wherein said picture output selector further comprises at least one input port, utilized to connect and choose to use other video facilities.

5. the system of claim 4, further comprising a pictures overlapping device, said overlapping device being connected to said twin pictures cutting processor, said other video facilities and said picture display selector, receiving the image signals input from said twin pictures cutting processor and said other video facilities, and outputting the image signals to said picture display selector, in addition, enabling the cutting pictures of the left and right camera to be overlapped on said other video facilities.

6. The system of claim 5, further comprising a picture display signal controller, connected to said picture display selector, enabling a user to use said controller to decide which mode of picture to display.

7. A traffic condition monitoring system with cameras for vehicle, comprising:
two cameras installed at the left and right flank side of the rear end of a vehicle respectively, the output images from the cameras being left and right reversing mirror reflecting images;
a twin pictures cutting processor, connected to said two cameras, receiving and processing input image signals;
a picture display selector, connected to said twin pictures cutting processor, receiving input image signals from said twin pictures cutting processor;
a picture output selector, connected to said picture display selector and the left and right signal lights, receiving the image signals input from said picture display selector and sensing the input signals of the left and right signal light; and
a monitor, connected to a picture output selector, receiving and displaying the input signal from said picture output selector.

8. the system of claim 7, further comprising a left-or-right camera selector, connected to said two cameras, said picture display selector and the left and right light, receiving the image signals of said two cameras and outputting the image signals to said picture display selector, and sensing input signals of the left and right signal light to decide to choose the single picture of said left or right camera.

9. The system of claim 7, further comprising:
a manual left and right camera picture display controller, connected to said picture output selector, said controller can let the pictures of the left and right camera display on said monitor simultaneously.

10. The system of claim 7, wherein said picture output selector further comprises at least one input port, utilized to connect and choose to use other video facilities.

11. the system of claim 10, further comprising a pictures overlapping device, connected to said twin pictures cutting processor, said other video facilities and said picture display selector, receiving the image signals input from said twin pictures cutting processor and said other video facilities, and outputting the image signals to said picture display selector, in addition, enabling the cutting pictures of the left and right camera to be overlapped on said other video facilities.

12. The system of claim 11, further comprising a picture display signal controller, connected to said picture display selector, enabling a user to use said controller to decide which mode of picture to display.

13. The system of claim 1, further comprising a front-or-rear control selector, connected to said two front cameras, said twin pictures cutting processor and said left-or-right camera selector, receiving the input image signals of said two front cameras, and outputting the image signals to said twin pictures cutting processor and said left-or-right camera selector.

14. The system of claim 7, further comprising a front-or-rear control selector, connected to said two rear cameras, said twin pictures cutting processor and said left-or-right camera selector, receiving the input image signals of said two rear cameras, and outputting the image signals to said twin pictures cutting processor and said left-or-right camera selector.

15. The system of 13, further comprising a front-or-rear selecting control button, connected to said front-or-rear control selector, said control button enabling said front-or-rear control selector to choose the input image signals of said front cameras.

16. The system of 14, further comprising a front-or-rear selecting control button, connected to said front-or-rear control selector, said control button enabling said front-or-rear control selector to choose the input image signals of said rear cameras.
